(19) United States
(12) Patent Application Publication
(10) Pub. No.: US 2002/0152210 A1
(43) Pub. Date: Oct. 17, 2002

(54) System for providing access to multiple disparate content repositories with a single consistent interface

(75) Inventors: Sean Allen Johnson, Charlotte, NC (US); Jeffrey Boyd Rayfield, Charlotte, NC (US); Marc Horer Andrews, Charlotte, NC (US)

Correspondence Address: Kimberly B. Gatling, Smith Helms Mulliss & Moore, L.L.P., P.O. Box 21927, Greensboro, NC, 27420, US

(73) Assignee: Venetica Corporation

(21) Appl. No.: 09/824,694

(22) Filed: Apr. 3, 2001

(51) Int. Cl. G06F 7/00

(52) U.S. Cl. 707/9

(57) ABSTRACT

A system for providing access to a plurality of disparate content repositories comprising a client application program interface (API) that is configured to generate a user request to access content and metadata properties in a plurality of content repositories having a plurality of proprietary program interfaces, a plurality of bridges that translate the user request into a format understandable by the proprietary program interfaces of the plurality of content repositories, and a view services component that processes and converts results content from the plurality of content repositories into a format understandable by said client API. The system further includes an access services component that relays the user request from said client API to said plurality of bridges, and an exchange services server that enables import and export of content and metadata properties in the plurality of content repositories in an XML format.

### BACKGROUND OF THE INVENTION

The present invention relates to content repositories, and more particularly, to a system for providing access to unstructured content stored in multiple disparate content repositories.

Over the past few decades, most business enterprises have developed custom technologies to increase business productivity. Thus, unstructured content of many types has emerged, including office documents, product collateral, contracts, order forms, presentations, e-mails, invoices, CAD/CAM diagrams, design specifications, web pages, images, audio, and video, just to name a few. These content assets have become especially important to business enterprises in large industries such as financial services, manufacturing, pharmaceuticals, and government agencies, where many separate applications are used to generate documents and other unstructured content stored in dedicated repositories. In order to manage their content assets, these business enterprises have selected various content-controlling systems, including document management, imaging, enterprise report management, product data management (PDM), web content management, report management, collaborative tools, web publishing systems, and the like.

In order to compete in today's global society, these enterprises must be able to access and exchange content assets with frequency and speed. While the explosion of the Internet has eroded some access and exchange barriers, mechanisms for real-time document delivery from disparate content repositories are still needed.

In particular, enterprises typically send countless documents to each other in order to conduct business. While today's e-business solutions deliver some of the data contained in purchase orders and invoices, for example, they do not address situations where people within or outside the organization need access to supporting documents or the document itself is the essence of the transaction. Further the time and expense involved with printing, copying, packaging, and shipping documents can be substantial. Typically, the document is stored in one content repository, only to have the receiver recreate and store those documents in another content repository. For example, an automotive design may be designed by one company and refined by additional companies that develop a prototype, test, and optimize the design for performance and production. The designs pass back and forth between the companies, yet each company needs to be able to update and manage the content throughout its lifecycle using its own, familiar content system.

E-business applications, such as business-to-business (B2B) integration and collaboration, web portals, net markets and exchanges, and customer relationship management (CRM) systems have also become imperative for enterprises to stay competitive in today's global marketplace. Each part of an enterprise's business must be supported by content, which is often produced by different people in different departments. The e-business applications primarily focus on streamlining processes and are heavily dependent on the ability to access and exchange, content in real-time regardless of where the content is stored. In addition, many of the benefits of e-business solutions have not been realized because the required supporting content is stored in many disparate content repositories scattered within and beyond the enterprise. Content integration has traditionally been a timely and expensive undertaking. Moving all of the enterprise's content to a single content repository is usually not a viable option because enterprises cannot afford the productivity setbacks or the long-term loss of best of breed capabilities that comes with standardizing on a single repository. Also, mergers and acquisitions negate the possibility of enforcing a single enterprise standard.

Most enterprises have deployed multiple types of software to manage their content, so they have been forced to maintain multiple independent repositories having proprietary application program interfaces, as shown in FIG. 1. Consequently, enterprises have had to learn vendor specific programming skills. In addition, developers of e-business applications, such as enterprise resource planning, CRM, and enterprise information portals (EIP) solutions, have been forced to integrate with multiple specific content repositories in order to provide access to managed content. There is no single integration effort, however, that provides real time access and exchange of content stored in multiple disparate content repositories.

Accordingly, there is a need in the art for a system that provides a single, consistent method to access and exchange content stored in multiple disparate content repositories, regardless of the underlying systems used to manage the content. There is a further need in the art for a system that provides real-time exchange of content stored in multiple content repositories.

### SUMMARY OF THE INVENTION

The present invention provides a system for providing access to a plurality of disparate content repositories. In a preferred embodiment, the system includes a client application program interface (API) that is configured to generate a user request to access data in a plurality of content repositories having a plurality of proprietary program interfaces, a plurality of bridges that translate the user request to access data into a format understandable by the proprietary program interfaces of the plurality of content repositories, and a view services component that processes and converts results content from the plurality of content repositories into a format understandable by the client API. The system further includes an access services component that relays the user request to access data in the plurality of content repositories from the client API to the plurality of bridges, and an exchange services component that enables import and export of data in the plurality of content repositories in an XML format.

Preferably, the access services component maps metadata properties across the plurality of content repositories, and the client API is in a format selected from the group consisting of Java, component object model (COM), and web services.

A single bridge corresponds with a single content repository and each bridge is an Enterprise Java Bean (EJB) deployed in an application server. The system also includes a bridge factory that is configured to generate a new bridge to support each new content repository in the system. In a preferred embodiment, each bridge answers client requests via a mode selected from the group consisting of remote method invocation (RMI), Internet Inter-ORB Protocol (IIOP), and extensible markup language (XML) over hypertext transport protocol (HTTP). Also in a preferred embodiment, each bridge accesses its underlying content repository via a mode selected from the group consisting of Java, Component Object Model (COM), and Java Native Interface (JNI) application program interface (API) calls.

The view services component is an Enterprise Java Bean (EJB) and comprises at least one converter that converts results content into an internet browser readable format. The view services component also includes at least one processor that processes results content by scaling, rotating, or enhancing the image.

### BRIEF DESCRIPTION OF THE DRAWINGS

The present invention is better understood by a reading of the Detailed Description of the Preferred Embodiments along with a review of the drawings, in which:

FIG. 1 is a block diagram of the prior art in which an enterprise's content is stored in multiple content repositories having proprietary application program interfaces.

FIG. 2 is a block diagram of the system of the present invention.

FIG. 3 is a flowchart of the process in which a user is initialized into the system of FIG. 1.

FIG. 4 is a flowchart of the process in which a user executes a query across the multiple content repositories in the system of FIG. 1.

FIG. 5A is a flowchart of the process in which a user displays the content of a search result by processing the content in accordance with the present invention.

FIG. 5B is a flowchart of the process in which a user displays the content of a search result by converting the content in accordance with the present invention.

FIG. 6 is a flowchart of the process in which a user is finalized from the system of FIG. 1.

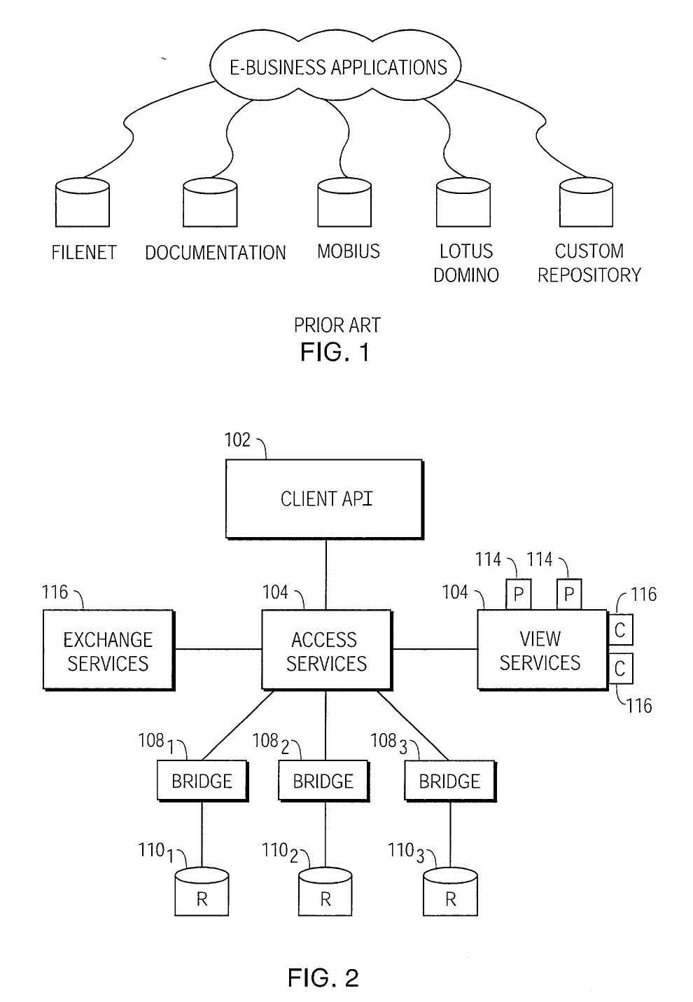

### DETAILED DESCRIPTION OF THE PREFERRED EMBODIMENTS

The illustrations and examples discussed in the following description are provided for the purpose of describing the preferred embodiments of the invention and are not intended to limit the invention thereto.

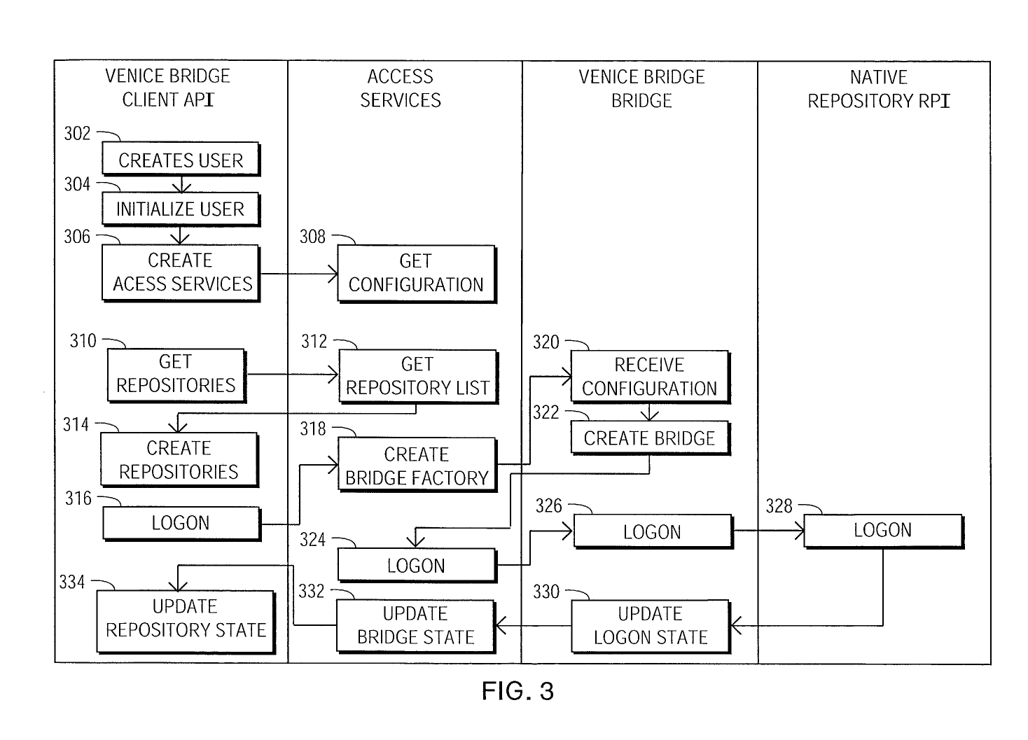

As shown in FIG. 2, the system of the present invention generally comprises a client application program interface (API) 102, an access services component 104, a view services component 106, an exchange services component 116, and a plurality of bridges 108 that correspond with a plurality of disparate content repositories 110.

The API 102 provides the interface for a software application written to provide a user access to the system of the present invention. Specifically, the API 102 enables an end user to search, update, display, add, and manage content in a plurality of disparate content repositories 110 using a single, consistent interface. The API 102 provides a superset of the capabilities of the existing commercial document and image management repositories 110. This interface enables the development of software applications that can access content regardless of where it is stored and without using vendor-specific interfaces for each content repository 110 or being aware of the type, vendor or location of the accessed content repositories 110.

In a preferred embodiment, the API 102 is available in three formats, Java, Component Object Model (COM) and web services. These formats address today's most popular development environments. The Java API 102 may be used in Java applications, Java applets, Servlets, Java Server Pages, or Enterprise Java Beans (EJB). The COM form of the API 102 enables development of Visual Basic, Visual Basic for Applications (VBA), Active Server Pages (ASP/ASP+), Windows Scripting Host, Delphi, Power Builder, Visual C++, C++ Builder, C#, and all .NET and OLE automation applications. The web services form of the API 102 enables development from any environment that can support sending extensible markup language (XML) over the hypertext transport prototcol (HTTP) protocol.

The core server components of the system of the present invention are the access services server 104, the view services server 106, and the exchange services server 116. These server components are Enterprise Java Beans (EJB) deployed in a compliant server computer. The server computer may run on a wide variety of platforms, including Sun Solaris, IBM AIX, HP-UX, Linux, and Windows NT/2000. By utilizing EJB standards, customers of the present system are able to select an application server that provides the appropriate robustness and economy for their solution. Such application servers may include BEA Web Logic, IBM WebSphere, Netscape/iPlanet Application Server, and Oracle Application Server. Thus, the system's components may be run from a single server computer or distributed across several server computers to enhance the performance and scalability of the overall system.

The access services component 104 acts as the interface between user requests from the API 102 and the disparate content repositories 110. Specifically, access services 104 relays the user requests to the appropriate content repositories 110 via bridges 108. Access services 104 also aggregates the results of user requests and returns the information to the API 102, along with any content requested in the desired format. Access services 104 further provides a data dictionary that maps metadata properties across different repositories to solve the problem of inconsistent field naming conventions across multiple repositories 110. For example, a metadata property for account number may be referred to as ACCT_NUM in one repository and ACCT_NO in another repository. The data dictionary in access services 104 references these different names for the metadata property under a single, uniform alias. This feature enables the user to perform a single search against all repositories or transfer documents from one repository to another.

As noted above, the API 102 enables end users of a software application to search, update, display, add, and manage content in a plurality of content repositories 110 using a single, consistent interface. Access services 104 enables the software application to perform these functions. Particularly, access services 104 enables an application to:

Search for Content—Perform metadata property and full text queries against one or more content repositories 110;

Capture Content—Add documents and other content to existing repositories 110 and apply metadata property values using a common set of procedures;

Control Content—Retrieve, copy, export, delete and transfer content between repositories or access repositories while maintaining metadata property values, content versioning information, and other content attributes;

Retrieve Content—Retrieve content from repositories 110 in its native form, and convert it into a browser ready format such as JPEG or HTML or wrap it in an XML document that maintains metadata property values;

Control Hierarchies—Navigate, create, update, and delete folders and content that form a taxonomy within one or multiple content repositories 110;

Update Content—Make changes to content within existing repositories 110 and update metadata property values, while maintaining version control; and

Maintain Security—Ensure user access to only authorized content by taking advantage of the security features inherent in the respective repository 110 and allowing users to manipulate repository security settings to the extent that their security permissions allow them to do so.

The bridges 108 translate the user requests from access services 104 into requests that can be understood by the proprietary application program interfaces of the vendor-specific repositories 110. Thus, the present system enables an enterprise to access and search its existing content management infrastructure without depending on vendor specific interfaces. Each bridge 108 is an Enterprise Java Bean stateful session bean deployed in an application server. Each bridge 108 answers client requests through remote method invocation (RMI), IIOP (COBRA), or XML over HTTP and accesses the underlying repository through Java, COM or JNI API calls. These bridges 108 provide immediate access to the diverse repositories 110, and may be modified or extended to support unique or non-standard implementations of the repositories 110. In addition, the present system enables an enterprise to rapidly develop and implement new bridges 108 to accommodate newly developed or newly added vendor specific repositories 110, and repositories 110 in other systems. When a new bridge is created to support a new repository 110, all remaining components of the present system remain in tact.

The access services component 104 transfers results content from the repositories 110 to the view services component 106 so that the results content may be processed and converted into a format readable by the client API 102. Documents and image files are converted on the fly into browser-readable formats so that the user may view the content in a web browser. For example, converters 116 of view services 106 convert TIFF and MO:DCA images into JPEG, and office automation documents such as Word, Excel, Power Point, into HTML. The view services 106 component is also configured to process content from the repositories 110 using various processors 114. For example, processors 114 may scale, rotate, or enhance an image. View services 106 can also be expanded with additional converters 116 and processors 114 to support content types such as CAD and CAM. Therefore, view services 106 is able to display content from the repositories 110 without any repository-specific client software or image viewer being installed on the user's computer. The web browser user may access the converted or processed documents from any known web server such as Netscape, Microsoft IIS, or an Apache web server, using Servlets, applets, JSP, ASP, NSAPI, ISAPI, or CGI.

The exchange services component 116 enables interaction between enterprises by providing seamless export and import of content in disparate repositories 110, along with associated metadata properties, in an XML format. Access service's 104 ability to map metadata properties, as discussed above, supports exchange service's 116 dynamic movement of content between disparate repositories 110, consistent with the preferences of the independent enterprises.

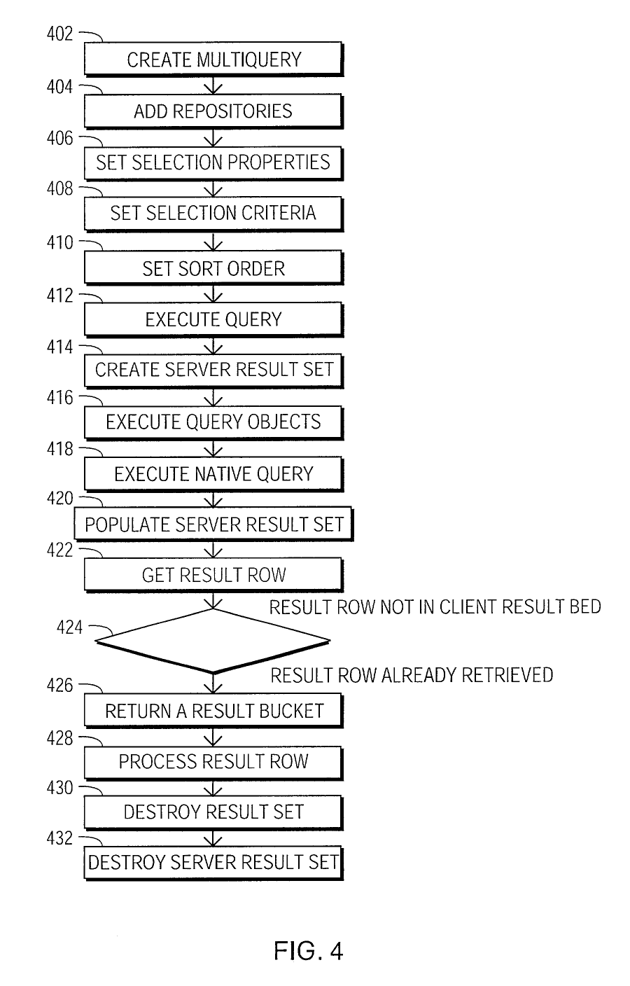

As shown in the flowcharts of FIGS. 3-6, the system of the present invention enables a user to log onto the system and perform many content management actions on the underlying content repositories 110. An example of an action is generating a query to search the repositories 110 using the client API 102, access services 104, and bridges 108. As shown in FIG. 3, the client API 102 creates (step 302) and initializes (step 304) each new user of the system. Upon initialization of the user, the API 102 creates an access services session with access services 104 by creating an object for access services 104 (step 306). An object is an independent program module written in an object oriented programming language. Access services 104 then determines the current configuration of the system (step 308). Next, the client API 102 requests access services 104 to direct the client API 102 on which repositories 110 in the system are accessible (step 310). Access services 104 generates the repository list (step 312) and provides it to the client API 102. The API 102 then creates repository objects for each accessible repository 110 (step 314).

The API 102 is configured to log the user onto each accessible repository 110 by proceeding with the following steps. The API 102 directs access services 104 to log the user on to a particular repository 110 (step 316). Access services 104 then creates a bridge bean, which creates the bridge 108 to the requested repository 110 using that bridge's 108 bridge factory (step 318). The bridge bean receives the configuration from access services 104 (step 320) and then creates the actual bridge 108 for the repository 110 (step 322). After creating the bridge 108, the log on command is passed from access services 104 (step 324), to the bridge 108 (step 326), to the application program interface of the native repository 110 (step 328). The bridge 108 then updates the logon status to indicate whether the user has succeeded or failed in logging onto the repository 110 (step 330). A user may fail to log onto a repository 110 by entering an incorrect password, for example. The response to update the logon status is then passed to access services 104 (step 332) and the client API 102 (step 334). At this point, the user is initialized and logged on to the requested repository 110. This procedure may be followed to log the user onto individual ones or all of the accessible repositories 110 on the system.

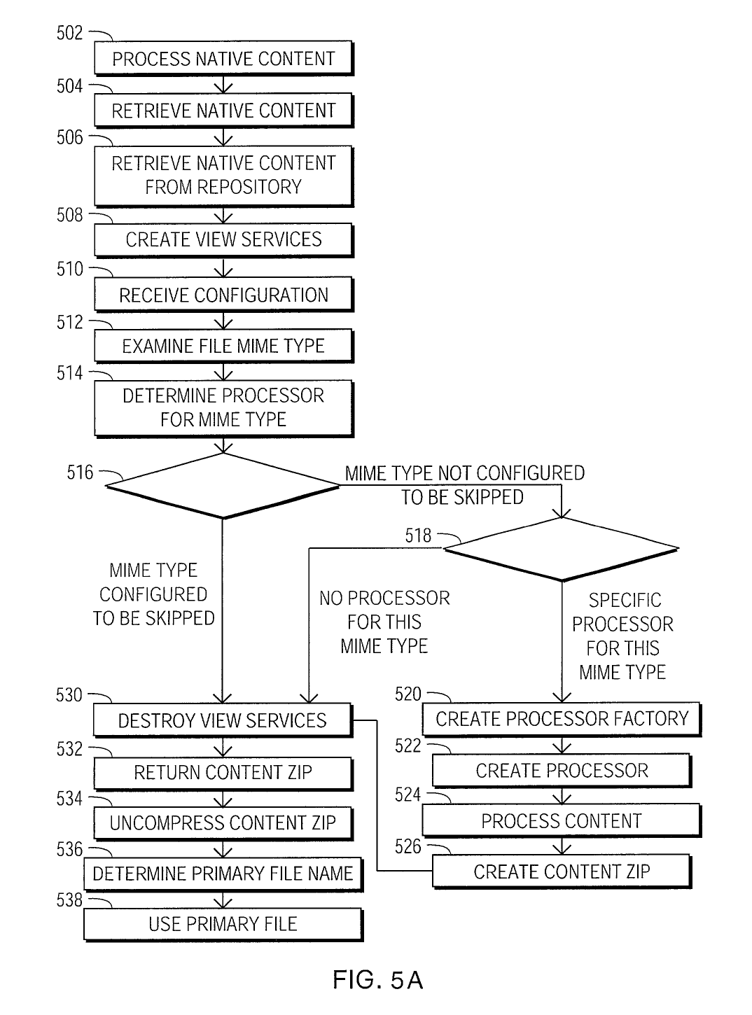

Assuming that the user in this example has logged onto five of the accessible repositories 110 of the system, the user is now prepared to execute a search of the repositories, as shown in the flowchart of FIG. 4. The user declares its intent to create a query in the client API 102 (step 402). The client API then adds the repositories 110 to the search request so that the query knows which repositories 110 should be searched (step 404). Assume in this example that the user wishes to perform the query in only three of the repositories 110 in which he/she is logged onto.

Next, the user selects the query properties via the client API 102 (step 406). The query properties are those metadata properties that the user desires to return from the search. For example, “what is the value of the account open date property of this content?” or “what is the value of the release status property of this content?” Next, the user selects the query criteria (step 408), which is the metadata information about the content already known by the user, such as “the account number property is 12345.” In addition to metadata properties searching, full text search criteria may be specified for the query, such as “content containing the phrase ‘promotion cycle.’” Therefore, the system knows what to search for and what metadata properties to return for each resulting content item. The system also knows which repositories 110 should be searched for the information. The user is next able to specify the sort order via the client API 102, which is the order in which the search results should be returned (step 410). At this point, access services 104 initiates the process of executing the query defined by the user in the API 102 (step 412). Access services 104 creates a server result set (step 414), which is a temporary storage object for holding the results of the search on the server. Until the actual search is executed, the server result set remains empty. Access services 104 next executes query objects by dispatching the query objects (step 416) to the three bridges 108 for the three repositories 110 that will be searched. Simultaneously, each bridge 108 executes the search by converting the search request from the user into one that can be read by the application program interface of the corresponding native repository 110 (step 418). As the search is executed in a particular repository 110, the server result set becomes populated (step 420). When execution of the search is completed in all the repositories 110, the server result set has been fully populated with the cumulative results.

A result set, which is a temporary storage object in the client API 102, is populated with a count of the number of rows of results in the server result set. The result set does not, however, include the actual result data, which is stored in the server result set. The user requests to retrieve a particular row set of rows of data via the client API 102 (step 422). For example, the user may request to view the results of row 5 or rows 5-10. Next, the client API determines whether requested rows are already available in the result set (step 424). If the requested rows are not available in the result set, the user retrieves the information for a set of rows including the requested row from the server result set (step 426). The API 102 then provides the results and the user is able to manipulate the data as desired. If, however, the result set has already retrieved the content of the requested rows, the client API 102 simply provides the contents of the requested row/row(s) and the user is able manipulate the contents as desired (step 428).

Once the user indicates that he/she is done with the search results for the query, the client API 102 deletes the result set (step 430) and access services deletes the server result set (step 432). The client may then proceed to execute a new query because the user is still initialized in the system.

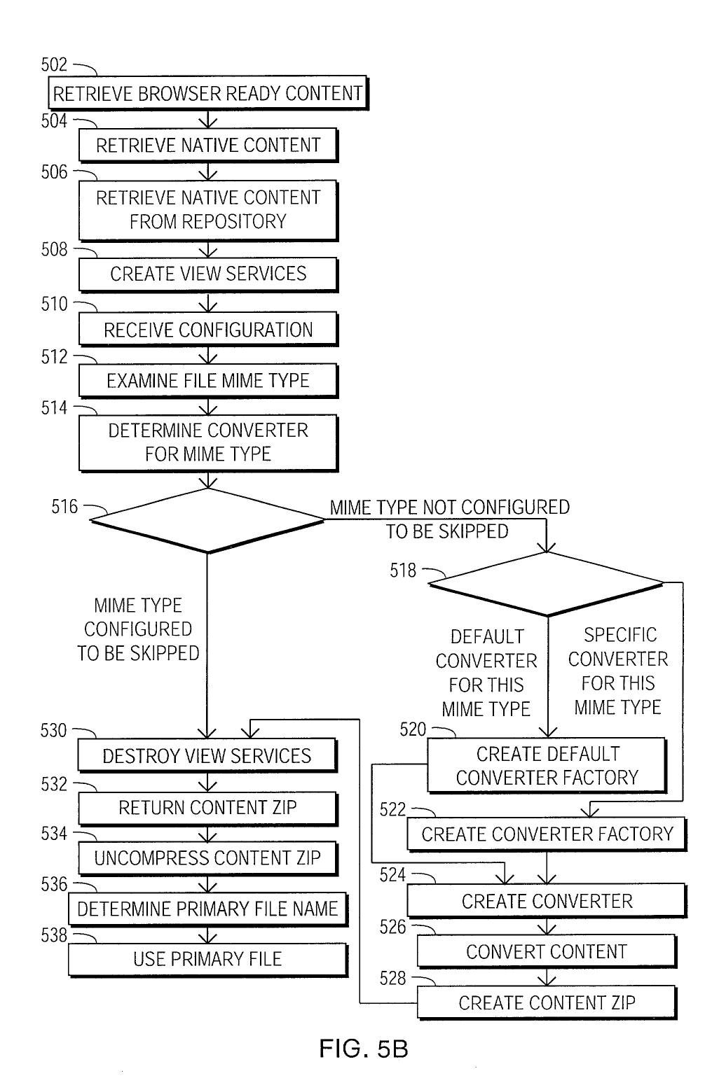

As discussed above with respect to step 422, the client API 102 provides the content of the search results rows requested by the user. The flowcharts of FIGS. 5A and 5B illustrate how the native content described by the metadata properties of the row can be converted or processed for display via the view services component 106. As further discussed above, processors 114 are used by view services 106 to process images by scaling, cropping, and zooming, for example. Converters 116 are also used by view services 106 to convert contents into a format that can be displayed by a web browser. For example, a converter 116 may convert a TIFF image to a GIF image.

The user initiates a request in the client API 102 to either retrieve the browser ready content of the selected row or process the native content of the selected row, depending on whether a processing function or conversion function is necessary (step 502A, 502B). In the case of processing content, the user specifies how the content should be processed, for example, scale it to twice the original size and darken the image. Access services 104 then initiates a request to retrieve the native content of the selected row from the corresponding repository 110 (step 504A, 504B). The bridge 108 retrieves the content in its native content form from the corresponding repository 110 (step 506A, 506B) and access services 104 creates a view services instance (step 508A, 508B). View services 106 next receives the system configuration from access services 104 (step 510A, 510B), which includes information about the processors 114 and/or converters 116 that are available for use by view services 106.

In the case of processing contents, as shown in FIG. 5A, view services 106 examines the mime type of the contents of the selected row (step 512A) and determines the type of processor 114 is needed to process the content by using the content's mime type (step 514A). The mime type is a standard identification code that identifies audio, video, and other file types so that appropriate programs or plug-ins can handle the content.

If view services 106 determines that the contents do not need to be processed (step 516A), then the view services instance is simply destroyed (step 530A). In the case where it is determined that the contents need to be processed, view services 106 determines whether a specific processor 114 can be created for that mime type (step 518A). If no processor 114 for that mime type can be created, access services 104 simply destroys the view services instance (step 530A). On the other hand, if view services 106 determines that a specific processor 114 for the mime type may be created, view services 106 creates a processor factory (step 520A). The processor factory is used by view services 106 to create processors 114 as they are needed. View services 106 then creates the processor 114 (step 522A) and processes the content by scaling, cropping, or rotating it, for example (step 524A). After processing the content, view services creates a content zip object (step 526A), which is an object that includes the compressed collection of the processed content files and identification of the contents. Access services 104 then destroys the view services instance (step 530A).

In the case of converting contents, as shown in FIG. 5B, view services 106 examines the mime type of the contents of the selected row (step 512B) and determines the type of converter 116 needed to convert the content using the mime type of the contents of the selected row (step 514B).

If view services 106 determines that the contents do not need to be converted (step 516B), the view services instance is simply destroyed (step 530B). In the case where it is determined that the contents need to be converted, view services 106 determines whether the default converter 116 is to be used or whether a specific converter 114 must be created for that mime type (step 518B). If it is determined that the default converter should be used for the mime type, view services 106 creates a default converter factory (step 520B). The default converter factory is used by view services 106 to create a default converter. If it is determined that a specific type of converter for the mime type is needed, view services 106 creates a converter factory to create the specific type of converter (step 522B). View services 106 then creates either the default converter or the specific type of converter 116 (step 524B) and converts the content (step 526B). After converting the content, view services 106 creates a content zip object (step 528B) and access services 104 destroys the view services instance (step 530B), as discussed above with respect to processing content.

At this point, view services 106 has either converted or processed the content and created a content zip object. In addition, access services 104 has destroyed the instance of view services. Access services 104 then returns the content zip object to the client API 102 (step 532A, 532B). The client API 102 uncompresses the content zip file (step 534A, 534B) and stores the converted or processed files on disk. The client API 102 also determines the primary file name (step 536A, 536B) and enables the user to use the file by, for example, displaying the file contents using a web server and a browser or the client API 102 Java viewer component (step 538A, 538B).

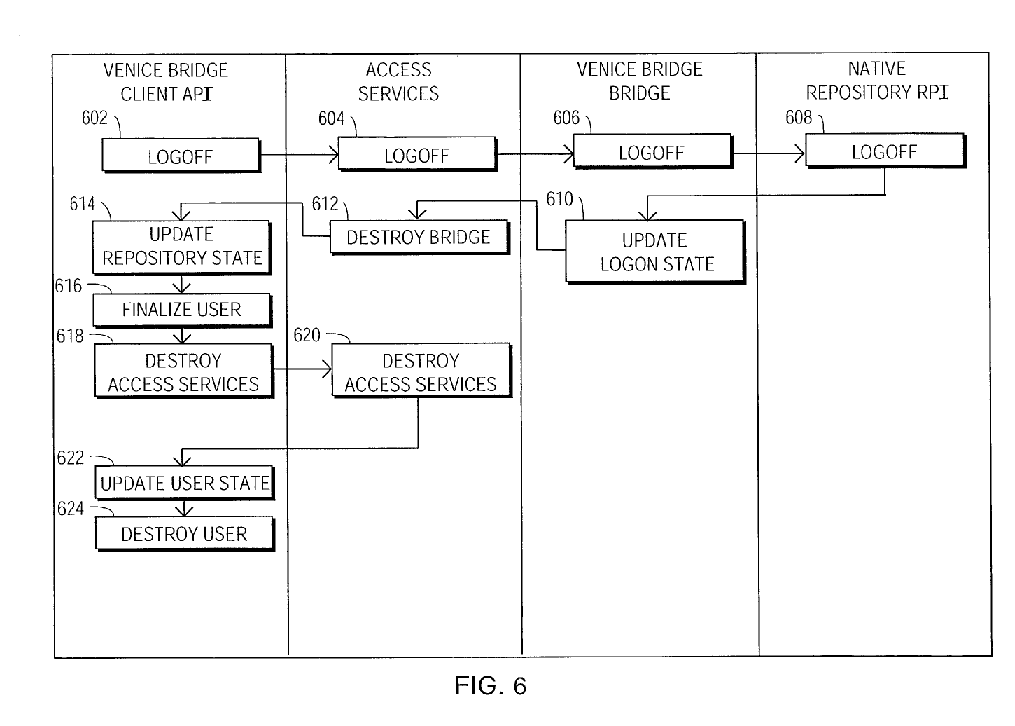

When the client is finished accessing a particular repository 110, the user logs off the repository as shown in FIG. 6. The user initiates the logoff command in the client API 102 (step 602) and the command is passed to access services 104 (step 604), the bridge server (step 606), and the application program interface of the corresponding native repository 110 (step 608). The bridge 108 then updates the user's status as being logged off the repository 110 (step 610). Access services destroys the bridge 108 to the repository 110 (step 612) and returns to the client API 102 to update the repository state as being “logged off” (step 614).

At this point, the user is still initialized in the system so he/she can continue to perform actions on the repositories 110 in which he/she is still logged onto. When the user has logged off of all the repositories it logged into in this session, the user instructs the client API 102 to finalize the user (step 616). The client API 102 then instructs access services 104 to destroy the access services instance (step 618) and access services 104 destroys its instance (step 620). The client API 102 updates the user's status as being unitialized (step 622), and the client API 102 destroys the user (step 624).

This process of enabling a user to utilize multiple disparate content repositories with a single, consistent interface is advantageous because it allows enterprises to access, manage and exchange content regardless of how many disparate backend systems the enterprise uses to manage their content. The system of the present invention does not replace existing content management systems. Rather, it unifies their power because the bridges are able to transcend vendor barriers as well as barriers between repository types such as electronic document management, imaging, report management, web content management, and PDM repositories. Therefore, enterprises that utilize the present invention are able to locate and retrieve content, regardless of where and how the content is managed. In addition, independent software vendors are able to focus on e-business solutions, rather than building and maintaining costly integration with multiple repositories. Enterprises are further able to enhance business by exchanging and moving documents across multiple repositories during the lifecycle of a customer or document.

Certain modifications and improvements will occur to those skilled in the art upon a reading of the forgoing description. By way of example, the present system is not limited to any number of repositories and corresponding bridges. The bridge service provider interface (SPI) enables the creation of a new bridge for each new content repository that is desired to be accessed by the client API 102. All such modifications and improvements of the present invention have been deleted herein for the sake of conciseness and readability but are properly within the scope of the following claims.

What is claimed is:

1. A system for providing access to a plurality of disparate content repositories comprising:
a client application program interface (API) that is configured to generate a user request to access content and metadata properties in a plurality of content repositories having a plurality of proprietary program interfaces;
a plurality of bridges that translate the user request into a format understandable by the proprietary program interfaces of the plurality of content repositories; and
a view services component that processes and converts results content from the plurality of content repositories into a format understandable by said client API.

2. The system of claim 1 further comprising an access services component that relays the user request to access content and metadata properties in the plurality of content repositories from said client API to said plurality of bridges.

3. The system of claim 2 wherein said access services component maps metadata properties across the plurality of content repositories.

4. The system of claim 1 further comprising an exchange services server that enables import and export of content and metadata properties in the plurality of content repositories in an XML format.

5. The system of claim 1 wherein said client API is in a format selected from the group consisting of Java, component object model (COM), and web services.

6. The system of claim 1 wherein a single bridge corresponds with a single content repository.

7. The system of claim 1 wherein said view services component is an Enterprise Java Bean (EJB).

8. The system of claim 1 wherein each bridge is an Enterprise Java Bean (EJB) deployed in an application server.

9. The system of claim 1 further comprising a bridge factory that is configured to generate a new bridge to support each new content repository in the system.

10. The system of claim 1 wherein said view services component comprises at least one converter that converts results content into an Internet browser readable format.

11. The system of claim 1 wherein said view services component comprises at least one processor that processes results content by scaling, rotating, or enhancing an image.

12. The system of claim 1 wherein each bridge answers client requests via a mode selected from the group consisting of remote method invocation (RMI), Internet Inter-ORB Protocol (IIOP), and extensible markup language (XML) over hypertext transport protocol (HTTP).

13. The system of claim 1 wherein each bridge accesses its underlying content repository via a mode selected from the group consisting of Java, Component Object Model (COM), and Java Native Interface (JNI) application program interface (API) calls.

14. A method for providing access to a plurality of disparate content repositories comprising the steps of:
enabling a user to generate a request in a client application program interface (API) to access content and metadata properties in a plurality of content repositories having a plurality of proprietary program interfaces;
translating, with a plurality or bridges, the user request into a format understandable by the proprietary program interfaces of the plurality of content repositories; and
processing and converting results content from the plurality of content repositories into a format understandable by the client API.

15. The method of claim 14 further comprising the step of relaying the user request to access content and metadata properties in the plurality of content repositories from the client API to the plurality of bridges.

16. The method claim 14 further comprising the step of mapping metadata properties across the plurality of content repositories.

17. The method of claim 14 further comprising the step of importing and exporting content and metadata properties in the plurality of content repositories in an XML format.

18. The method of claim 14 further comprising the step of corresponding a single bridge with a single content repository.

19. The method of claim 14 further comprising the step of generating a new bridge to support each new content repository in the system.

20. The method of claim 14 further comprising the step of converting results content into an Internet browser readable format.

21. The method of claim 14 further comprising the step of processing results content by scaling, rotating, or enhancing an image.

22. A computer readable media comprising software for providing access to a plurality of disparate content repositories, the software being configured to instruct a computer to:
enable a user to generate a request in a client application program interface (API) to access content and metadata properties in a plurality of content repositories having a plurality of proprietary program interfaces;
translate, with a plurality or bridges, the user request into a format understandable by the proprietary program interfaces of the plurality of content repositories; and
process and convert results content from the plurality of content repositories into a format understandable by the client API.

23. The computer readable media of claim 22 wherein the software is configured to further instruct a computer to relay the user request to access content and metadata properties in the plurality of content repositories from the client API to the plurality of bridges.

24. The computer readable media of claim 22 wherein the software is configured to further instruct a computer to map metadata properties across the plurality of content repositories.

25. The computer readable media of claim 22 wherein the software is configured to further instruct a computer to import and export content and metadata properties in the plurality of content repositories in an XML format.

26. The computer readable media of claim 22 wherein the software is configured to further instruct a computer to correspond a single bridge with a single content repository.

27. The computer readable media of claim 22 wherein the software is configured to further instruct a computer to generate a new bridge to support each new content repository in the system.

28. The computer readable media of claim 22 wherein the software is configured to further instruct a computer to convert results content into an Internet browser readable format.

29. The computer readable media of claim 22 wherein the software is configured to further instruct a computer to process results content by scaling, rotating, or enhancing an image.
